(19) United States
(12) Patent Application Publication
(10) Pub. No.: US 2003/0120584 A1
(43) Pub. Date: Jun. 26, 2003

(54) System and method for managing market activities

(75) Inventors: Kurt A. Zarefoss, Middletown, MD (US); Lisa Carlin, Frederick, MD (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Manugistics, Inc.

(21) Appl. No.: 10/313,351

(22) Filed: Dec. 6, 2002

Related U.S. Application Data
(60) Provisional application No. 60/336,147, filed on Dec. 6, 2001.

(51) Int. Cl. G06F 17/60

(52) U.S. Cl. 705/37; 705/10

(57) ABSTRACT

A system and method for sharing and managing supply chain data including data relating to market activities. The system generates an item called a market activity, which may be accessed by one or more users. The system may comprise of several other logistical systems and/or may interface with other systems providing a number of functionalities relating to market activity data and other data useful in implementing and evaluating market activities. The system may further control user access to supply chain data based upon the status of the market activity.

### CROSS REFERENCE TO RELATED APPLICATIONS

This application claims priority from U.S. Provisional Patent Application No. 60/336,147 filed Dec. 6, 2001, the disclosure of which is hereby incorporated by reference in its entirety.

### BACKGROUND OF THE INVENTION

1. Field of the Invention

The present invention relates to a method and system for managing market activities, more particularly, the invention relates to a method and system for monitoring, sharing, integrating and manipulating information relating to market activities to facilitate the exchange of highly relevant marketing information between supply chain trading partners.

2. Discussion of the Related Art

A supply chain network generally comprises of a network of many types of trading partners including buyers, sellers, retailers, distributors, suppliers, and the like. Trading partners may also be both internal and external. That is, trading partners may reside within the same organization (e.g., company) or may represent completely non-related entities. Each of the supply chain trading partners may have both a direct and indirect relationship with other supply chain trading partners. In order for a supply chain trading partner to operate most effectively, it may be very helpful for the supply chain trading partner to be able to have immediate access to information relating to any supply chain activities that may impact the trading partner both directly and indirectly. Advance knowledge of certain supply chain activities, such as the implementation or cancellation of marketing activities that may temporarily increase or decrease demand, may be especially helpful to supply chain trading partners. Therefore, the sharing of critical supply chain data among the trading partners is an essential ingredient in developing a responsive and efficient supply chain network.

A supply chain is a network of relationships that may reach all corners of a business organization extending beyond the boundaries of the organization and reaching out to external parties. As the supply chain extends outside the four walls of an organization, companies need a way to streamline collaborative efforts relating to the sharing of marketing activity data with their suppliers and/or customers. Supply chain trading partners may be partners in a conventional supply chain (e.g., retailers, manufacturers, suppliers, and the like) as well as participants in the process (e.g., sales, marketing, planners, logistics, and the like), and they need a better way to share information related to the creation, approval, planning, execution and evaluation of marketing activities. Trading partners may also be either a buy-side or sell-side participants as well as internal participants such as sales, marketing, merchandising, planners and logistics.

During the course of a typical year, a supply chain trading partner may participate in a number of marketing activities. Each of these activities may be referred to as a “market activity.” Market activities are activities relating to, for example, coupon offers, discounts, promotions, and the like. For supply chain trading partners of such a business, market activities of the business may raise important issues. For instance, an event such as a market activity may raise concerns over the ability to meet increase in orders. Therefore, it might be desirable for trading partners to be able to share forecasting data between the trading partners. Further, it may be important for each trading partner involved in a market activity may want to know about the exact status of the market activity such as whether it is being currently implemented and how well are the resulting sales. Thus, being able to continuously monitor and get updated information relating to market activities may be very useful to supply chain trading partners.

Today, companies are reaching outward to their trading networks, collaborating with their suppliers and customers to ensure effective communication and information sharing. This effort requires a simplified and streamlined method for sharing market activity data including information relating to the creation, approval, planning, execution, and evaluation of these market activity plans.

When marketing plans are created for a business using conventional methods, it is typically created by a central planning organization within the business using commercially available forecasting software that processes information received from either a sales and/or a marketing group in order to generate the marketing plan. It is often difficult, in the current environment of many organizations, to keep this information coordinated with the often numerous participants and activities required for a successful market activity. In addition, these organizations need a way to filter the information they receive so that they can prioritize and address the most critical exceptions or changes. They also need a way to seamlessly integrate this information with their optimization engines in the back shop as well as share this information with their supply chain partners outside the four walls of the business.

It may be especially difficult for a supply chain trading partner to obtain information relating to an upcoming market activity when they are not directly involved. Being able to find out about such events prior to the event occurring may be of great benefit in planning production, maintaining inventory and ordering supplies. This may be particularly true for upstream suppliers who would like to know when downstream supply chain trading partners are planning for a future market activity.

Therefore a system and method that provides a global view of all market activities associated with a location, a product, a product family and the like, which would simplify the process of coordinating and sharing market activity information related to market promotion is highly desirable. And more specifically, a robust system that allows real time information exchange and updating that is flexible and that can accommodate various constraints.

### SUMMARY OF THE INVENTION

Accordingly, the present invention is directed to a system and method for creating, processing, sharing and disseminating data related to market activities between supply chain trading partners.

According to an embodiment of the present invention, a system and method for the creation, approval, planning, execution, evaluation and sharing of market activity plans between supply chain trading partners are provided. The system and method further allows supply chain trading partners to merge market activity data with other types of data such as forecast, historical sales and actual sales data, and display the results on a single user interface. The system according to the present invention allows users to create an item called “market activity,” which may be defined by a name, description, type, status, campaign, start date and duration, along with any number of user defined attributes (UDAs). The status of a market activity indicates the actual status of the market activity, for example, whether the market activity has actually been implemented. UDAs may be such items as terms and conditions, display space, cost, objectives, and marketing. UDAs may be formatted in various ways, for example, free form text, measure, date, or URL data type. Any item that a business may plan for, such as DFUs and SKUs, can be assigned to a market activity.

According to another embodiment of the present invention, the system may streamline market activity collaboration methods for products. It may notify appropriate user[s] of business rule violations via email, pager, and other electronic devices. It may also filter alert information so that the most critical exceptions or changes can be prioritized and addressed first. Further, the system may share resulting market activity data with suppliers and/or customers.

According to another embodiment of the present invention, the system provides a configurable user interface, which supports the market activity process lifecycle to create, approve, plan, execute and evaluate market activities. The system allows a supply chain trading partner to view data for a market activity along with other types of data such as forecasting data on a single user interface regardless of whether or not the trading partner is directly involved in the market activity. The system may monitor the status of the market activity that is created and publish the market activity for viewing or editing by users. If the user has access to the market activity through publication, the user may either have view-only or editing rights. The system may be implemented by integrating a market activities manager system with other logistical applications. These systems work together resulting in a robust market management system that provides dynamic capabilities.

According to another embodiment of the present invention, the system may generate market activities that may be accessed by trading partners. These market activities can be used to submit offers from one trading partners to another. The system allows the recipient to accept or decline the market activity and notifies all interested parties of the acceptance or denial of the offer. Further, the system allows all interested parties to track and monitor the entire life cycle of a market activity including from inception to execution to evaluation. The system can provide a global view of all market activities that are associated with product, location, or product family, simplifying the process of coordinating market activity information related to market promotions.

According to another embodiment of the present invention, five stages are utilized to facilitate collaboration of market activities between trading partners and among internal participants such as sales, marketing, merchandising, planning, and logistics. The stages are: drafting; offering; planning; executing and evaluating stages.

In stage one, the drafting stage, a market activity relating to a particular product or set of product is authored. The market activity drafted may consist of a name, description, market activity type, campaign, planning items, proposed quantity, start and end date, terms and conditions, display space, and the like. During the draft mode, the system may be configured to only allow the author enterprise to see the market activity. The market activity includes all relevant data and information associated with the market activity for consideration by the retailer. Once the author is ready to send the market activity to the recipient enterprise, the status of the draft may be changed to “Offer.” Setting the status to “Offer” may trigger an alert. Users may view the various information stored in the system either by the market activities they are working on or by the products they are working with. The user may sort and organize data in order to prioritize and group their work.

In the second stage, the approval stage, the recipient evaluates a new market activity. If the recipient agrees with the terms and offer, the recipient indicates their approval by checking the “Approval” check box. The recipient can review historical performance data using for example, a collaboration application, in order to determine whether to approve this market activity. After reviewing the proposed market activity, the recipient may approve it. By approving the market activity, the market activity may be published and alerts may be sent to interested users using for example, a monitoring application. When the appropriate business rules are run, email notification may be sent to those users that have been identified in the business rule for notification of an approval.

Once the market activity is approved, the process enters the third stage, the planning stage. In this stage, planners change the status to “plan,” determine where the market activity will be run and provide a forecast for the market activity period. This information may be imported from a planning system at the planning item level or at a higher level in a hierarchy. Alternatively, the planner may enter a total forecast number for the market activity and allocate the forecast across the market activity period and down a hierarchy (i.e., from product family for a region to a product at a store). If time series data associated with the market activity end up exceeding configured thresholds, alerts may be sent to the planners and partners.

From the planning stage, the market activity moves into the execution stage. This stage includes the movement of product to the distribution centers and stores as well as receiving of actual sales during the market activity. Both partners may monitor the execution of the market activity by analyzing data using, for example, a supply chain data monitoring application. In addition, business rules may generate alerts when execution data falls outside the realm of agreed upon thresholds.

In the fifth stage, the evaluate market activity stage, the partners may evaluate the market activity and compare it with expected performance as well as past performance. The evaluation of the market activity may, however, be performed at any stage of the market activity or campaign.

According to another embodiment of the present invention, a user may be able to view market activity-related information in a number of ways. For example, the system allows users to view time series data based on different size time buckets (i.e., time increments). Users may also manipulate market activity-related information so that the user views the aggregated information according to planning items and organized into a hierarchy. The system also allows users to sort market activities by market activity type, status, and enterprise.

According to another embodiment of the present invention, an enterprise may act as the “host” enterprise for a market activity and may manage the market activity. The host may grant permission to users to access and/or edit market activities by assigning those users roles. Under these circumstances, specific filter[s] are assigned to specific roles, which allow those users assigned to the roles access to specified market activities. The combination of role assignment and filters allows for the assignment of different types of access, for example, read-only access or read/edit access or no access. Further, the permission to access may depend upon the status of the market activities.

According to another embodiment of the present invention, the information associated with market activities may be shown in various formats. For example, the information may be displayed in a table organized into a user defined hierarchical order. Alternatively, the information may be displayed as a Gantt chart.

According to another embodiment of the present invention, information associated with market activities may be updated by allocation methods. For example, a profile may be created, which is a pre-defined set of time intervals and weighted factors that is used to allocate updated information over a specified time interval.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 is a block diagram of a market management system according to an embodiment of the present invention;

FIGS. 2A and 2B depicts a process for creating, processing, disseminating, approving, planning, executing and evaluating a market activity;

FIG. 3 is a chart that shows types of data access that may be granted to an exemplary enterprise;

FIG. 4A is a user interface for an exemplary market activity;

FIG. 4B is a user interface showing planning items associated with the market activity displayed in the user interface of FIG. 4A;

FIG. 4C is a user interface for planning item management;

FIG. 5 is an exemplary user interface that shows how market activity data may be shown alongside forecasting data; and

FIG. 6 is a chart showing business rule types and their parameters.

### DETAILED DESCRIPTION OF THE PREFERRED EMBODIMENTS

Reference will now be made in detail to the preferred embodiment of the present invention, examples of which are illustrated in the accompanying drawings.

The invention disclosed herein incorporates by reference the subject matter of co-pending and commonly assigned U.S. Non-Provisional patent applications “System and Method for Supply Chain Management, Including Collaboration,” Zarefoss et al., application Ser. No. 09/965,854, filed Oct. 1, 2001; “System and Method for Supply Chain Demand Planning and Forecasting,” Singh et al., application Ser. No. 09/984,346, filed Oct. 29, 2001; and “System and Method of Monitoring Supply Chain Parameters,” Zarefoss et al., application Ser. No. 09/984,340 filed Oct. 29, 2001 and “System and Method for Viewing Supply Chain Network Metrics,” Kavounis et al., application Ser. No. 10/059,055, filed Jan. 30, 2002.

The market management system according to the preset invention can generate an item called “market activity,” which may be originated by any system user and accessed by other users. A market activity generally represents specific marketing event or events such as an offer for a particular product or set of products. A market activity can be authored by either the buy-side or sell-side trading partner or one of its users and may comprise of one or more attributes. Each user is typically associated with one trading partner. A market activity may be defined by certain attributes. For example, attributes for a name, description, market activity type, campaign, planning items, proposed quantity, start and end date, terms and conditions, display space, status, author enterprise, recipient enterprise, and the like, may define a market activity. A number of market activity types may be created and maintained by the host enterprise and used by the entire exchange or installation. These market activities may be classified into types of market activities. Each market activity type may be defined by a name, description and a color. Each market activity may be associated with a particular status at any given time. A set of pre-defined statuses may be created and maintained by a host enterprise and used by the entire exchange or installation. A campaign is an optional field that can be set to associate this market activity with a larger activity such as “back to school” or “Christmas.” In addition to the attributes described above, other user-defined attributes (“UDA”) may also be created. UDAs can be free form text, measure, date or URL data type.

The market management system may allow users to view market activity data together with other types of information such as projected or forecast data, which allows users to view data from different sources and for purposes on a single user interface. Further, the data may be integrated to provide useful view of supply chain data in a format that may be beneficial in terms of analysis of the data.

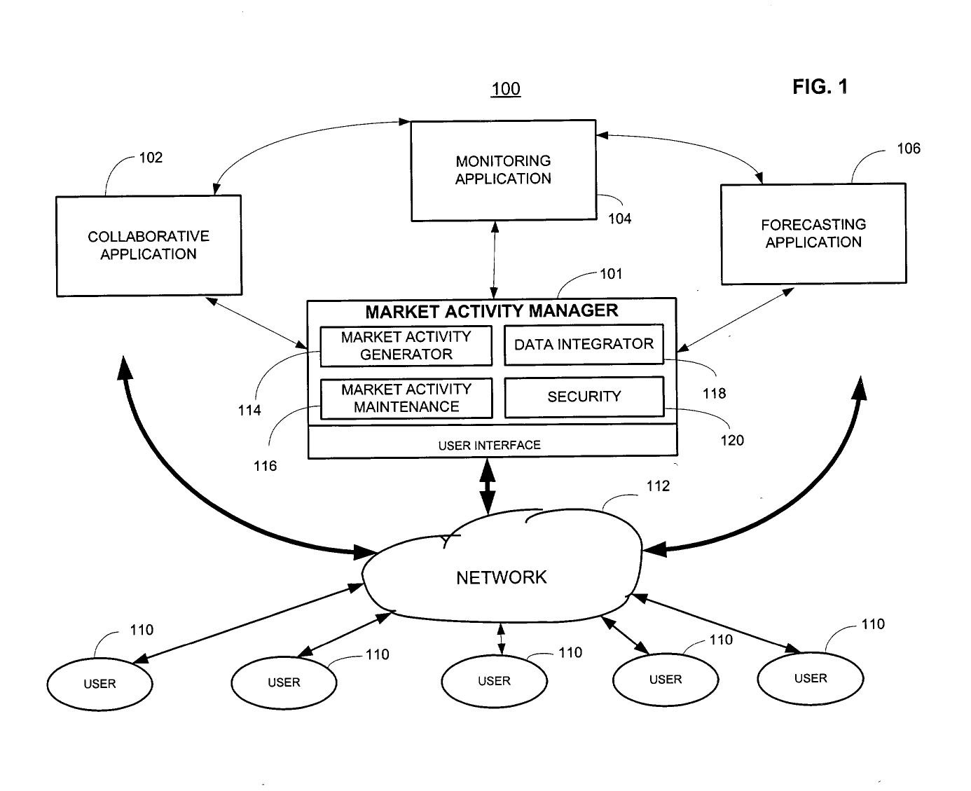

The market management system according to the present invention may comprise of several sub-systems in order to provide a robust monitoring, data gathering, promotion generating and approval system. The market management system may include a market activity manager system that interfaces with other logistical applications. For example, it may interface with a supply chain collaboration application, such as the system described in U.S. patent application Ser. No. 09/965,854, an information monitoring application, such as the system described in U.S. patent application Ser. No. 09/984,340, and a forecasting and planning application, such as the system described in U.S. patent application Ser. No. 09/984,346. Referring to FIG. 1, which is a block diagram of a market management system 100 (herein “system”). The system 100 may comprise of a market activity manager 101, which may be integrated with various logistical applications such as a collaborative application 102, a monitoring application 104 and a forecasting application 106. The market activity manager 101 may share data with the logistical applications 102, 104 and 106 exchanging data and processing the data received from the logistical applications 102, 104 and 106. The market management system 100 is part of a comprehensive supply chain management system, which allows management and control of various supply chain data including, for example, marketing activities data, forecasting data, historical sales data and actual sales data. The market activity manager 101 may directly exchange data users 110 and/or indirectly through one or more of the logistical applications 102, 104 and 106 via an electronic network 112 such as the Internet, Intranet, LAN, WAN, and the like. Users 110 are any individual or groups that that are part of a supply chain trading network. Typically a user 110 is associated with a trading partner. Trading partners may be a buyer, a seller or any other interested trading partner within the supply chain. Each of the logistical applications 102, 104 and 106 and the market activity manager 101 may provide and maintain their own database. Alternatively, one or more of the logistical applications 102, 104 and 106 and the market activity manager 100 may provide and maintain a common database. The market activity manager 101 may comprise of several modules including, for example, a market activity generator 114, a market activity maintenance module 116, a data integrator 118 and a security module 120. The market activity generator 114 facilitates the generation of market activities. The market activity maintenance module 116 facilitates editing, maintenance and monitoring of market activity data. Alternatively, the monitoring functionality may be performed by the monitoring application 104. The data integrator 118 facilitates the integration of data from various logistical systems. The security module 120 facilitates the sharing of market activities and its associated data by controlling access to the market activities. Alternatively, security functionalities may be provided by an external security application separate from the market activity manager 101. The functionalities that these modules provide will become more apparent with the description that follows.

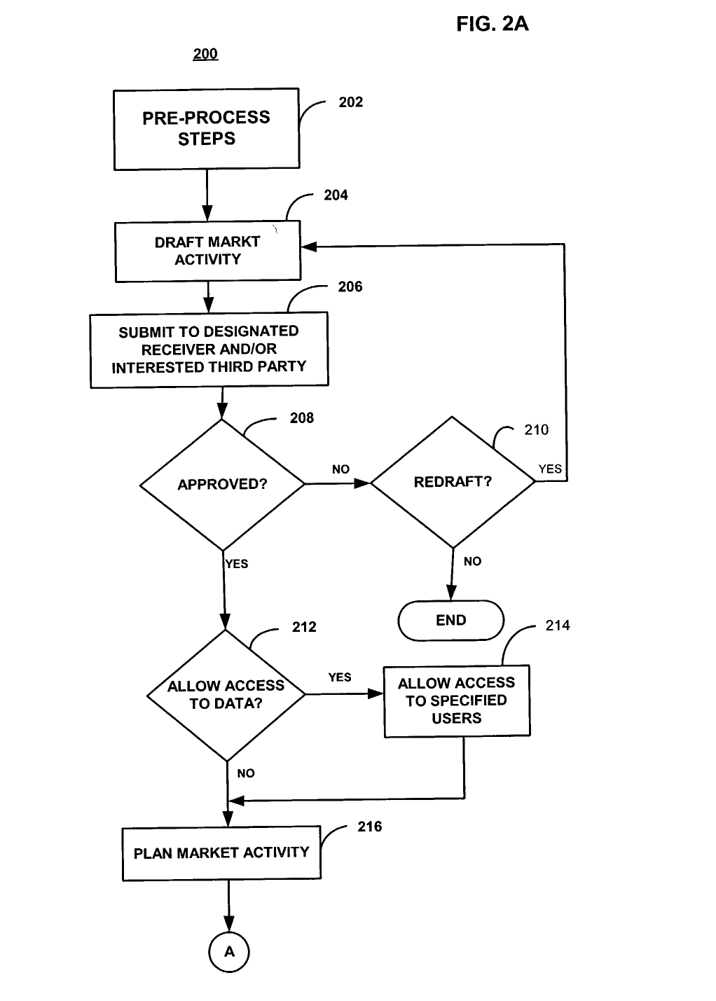

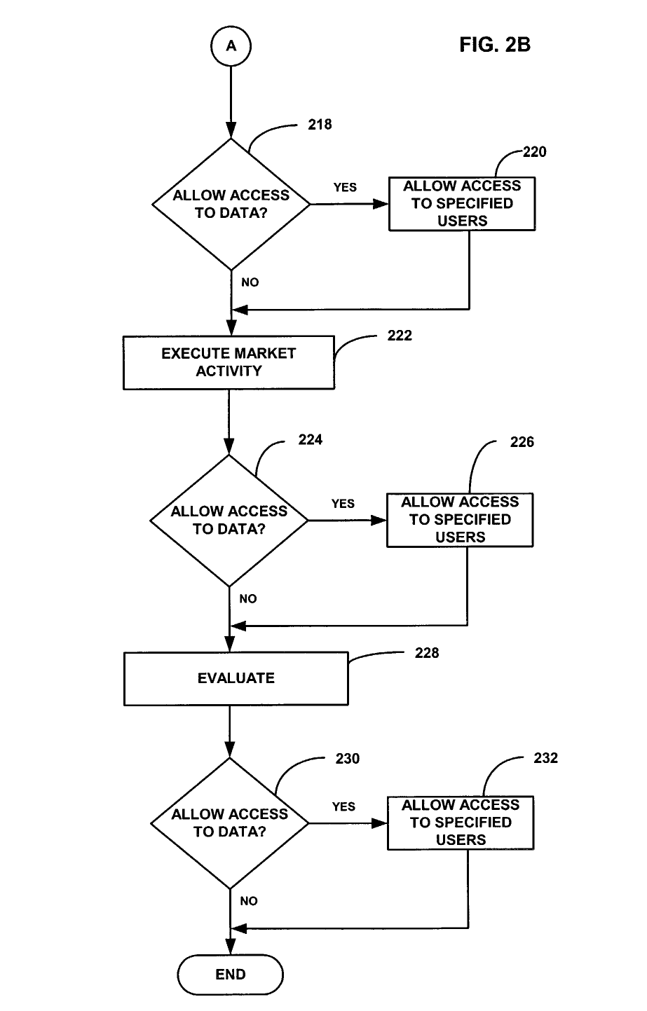

The market activities generated by the present invention may be used to facilitate collaboration between supply chain trading partners. A supply chain trading partner is typically a commercial enterprise that does business with a number of other supply chain trading partners both as a buyer and as a seller. These enterprises often comprise of a number of individuals and/or groups that are made up of individuals. FIGS. 2A and 2B depict a collaborative process 200 for generating and processing market activities between an author-trading partner and a recipient-trading partner in accordance with an embodiment of the invention. Associated with each author and recipient will be one or more user[s]. Thus, the author and the recipient may be two users instead of two trading partners. The process 200 begins at step 202, which is a pre-process step for generating and processing market activities. The pre-process step 202 actually comprises of a number of steps that sets up the general process for creating and processing market activities. These steps include the creation of various items such as filters, hierarchies, roles, planning components and items, business rules, and the like. These items allow the market management system to provide various functionalities including allowing system users to control access to data, generating alerts when a business rule has been violated, allowing users to view data from different perspectives and allowing users to process data optimally. The process then moves to step 204 where a market activity is drafted by filling data fields associated with the activity such as those described above (e.g., market activity name, description, market activity type, author enterprise, recipient enterprise, and the like). Once the draft is completed, the draft may then be submitted to the designated recipients for viewing and/or approval at step 206. Alerts may be generated and sent to interested users when the draft is completed. Relevant data will be release to only those users having permission to access the data. A determination is made as to whether the market activity is approved by the designated recipient at step 208. If the recipient does not approve, then the process moves to step 210, which determines whether the draft of the market activity is to be redrafted. If the market activity is to be redrafted then the process returns to step 204. If, on the other hand, the designated recipient approves the market activity then the system determines whether the approved market activity or other information is to be accessed by certain users at step 212. If so, then those users are allowed to access the relevant data at step 214. User access to relevant data will depend upon whether the users have permission to do so. Such permission to view or edit market activities or other data may be determined by role assignments and the user's enterprise identity. The release of relevant data may be initiated by a value or changes in a value in specific data fields of the market activity created. For instance, if the status of the market activity is changed from “draft” to “approved” then those users assigned to a particular role may be granted access to the relevant data based on their assigned role. The level of access (e.g., no access, read-only or editing) to relevant data will depend upon the role of the user, the user's enterprise identity and the current status of the market activity. Further, a business rule may be activated and an alert generated based on the value of one of the attributes of the market activity such as its status attribute. At step 216, the market activity is planned. At step 218 a determination is made as to whether relevant data (e.g., the approved market activity) should be allowed to be accessed by specific users based on the new status of the market activity. If so, then allow those specified users to access the data at step 220. The process then moves to step 222, which executes the market activity. At step 224, the system determines whether relevant data should be allowed to be accessed by specific users based on roles and filters assigned to the users and the new status of the market activity. If it is determine that access should be granted to certain users then access is given to those specified users at step 226. At step 228, the results of the executed activity are evaluated. After the evaluation is completed, the system determines again whether to allow access to relevant data to specified users at step 330. The data may include not only information relating to the market activity but may also include other information such as those relating to the evaluation of the market activity. If it is determine that the data should be released, then the data is allowed to be accessed by the users at step 332. Note that after each of the major steps (i.e., drafting step 204. approval step 208, planning step 216. executing step 222 and evaluation step 228) in process 200, the market management system checks to determine which users will have access to relevant data and what type of access they will have. Further, the determination of whether a user will have access to a market activity may be based on other attributes of the market activity other than the status attribute. The following describes some of the steps depicted in process 200 in greater detail.

In order to implement the various functionalities of the present invention, certain steps will be preferably undertaken. These steps include creating or defining certain items. These include roles, subscriptions, filters, hierarchies, business rules, planning components and items, partnerships, calendars, and the like.

One of the first steps during the pre-process stage is to identify trading partners (e.g., enterprises) and its users. Users will typically be associated with a specific trading partner. Users may be an employee of a trading partner, a group within the trading partner organization or a division within the organization. Once each of the participants (e.g., trading partners and users) is identified, roles and subscriptions may be created and assigned to appropriate participants.

Each user may be assigned to a role. The user's role along with the identity of the user's enterprise and the current status of the market activity will typically define what types of data will a user have access to and the type of access they may have (e.g., no access, read-only or edit). Subscriptions of the enterprise and/or user may also help define the types of access that the user may have. The ability to control access to data may be accomplished by the use of filter[s].

Planning components and planning items are key elements in collaborative systems. Planning components represents any kind of time series data that can be time allocated into any calendar allocation. Planning items represent any entity that a user would want to plan on, such as DFU or SKU. A planning item may have any number of user defined attributes associated with it. A planning item is defined by at least a product and location, any number of uniquely identifying user defined attributes. The relationship between planning components and items may be better understood by the following example. Suppose a car dealer at its dealership in Rockville, Md. sells convertible sedans. Suppose further that the car dealer has sales figures for that sedan at that dealership broken down into monthly sales figures. In this case, a planning item could be created having the attributes “convertible sedan” and “Rockville, Md.” Associated with this planning item are planning components, in this case, the monthly sales figures for the convertible sedan sold at the Rockville, Md. dealership.

A hierarchy is a pre-defined set of user defined attributes that establish a hierarchy in relation to other user defined attributes in the set. For instance, a location hierarchy may be created that breaks down a location attribute for planning items. The location hierarchy may be broken down by nation, region, state, and city. This allows system users to organize, process, analyze, and manage the data that they are interested by nation, region, state and city.

Business rules establish data thresholds. Business rules can establish limits and parameters, which when broken may initiate actions such as alerts or prevent certain actions to be taken. The system may provide a list of valid business rule types that may be selected for application. For all business rules, a user must provide the following parameters: business process, business rule type, business rule name, description, enterprise, priority, filter and user access.

Partnerships may be created between trading partners. A partnership defines what component data can be shared between enterprises. A partnership is comprised of two parts: the partnership relationship and the partnership components. The host enterprise owns and manages the partnership relationships by establishing what enterprise can collaborate with what other enterprises. The host enterprise is typically the channel master that sponsors and manages the supply chain trading community or is a third party provider that sponsors the community on behalf of its trading partners. The enterprise specified in the partnership relationship owns and manages the partnership components that specify which component versions they will publish to the enterprise specified in the partnership.

A more detailed discussion relating to these concepts along with discussions concerning other items such as calendars may be found in the U.S. patent applications referenced above.

The system 100 may generate and process market activities. A market activity is a special offer for a particular product or a set of products. Either a buy-side or sell-side trading partner may author a market activity. If the author is a buy-side trading partner, it may be used to inform a sell-side trading partner about the upcoming sales event. This gives sell-side partner[s] early warning about the upcoming event and allows sell-side partner[s] (the recipient of the market activity) an opportunity to plan for the event. Further, it may allow sell-side partners to relay to the buy-side partner that they are unable to meet their forecasted sales as a result of the event. It may even allow the sell-side partner to stop the market activity if the sell-side trading partners believe that they are unable to meet the increased orders that may result from the event. If the author is a sell-side trading partner, it may be used as an offer to buy-side trading partner. The buy-side trading partner may then directly accept the terms of the market activity and directly place an order through the market activity.

The draft and/or offer step 204 of FIG. 2A may be further understood with the following example. Suppose a manufacturer is interested in giving one of its customer, a retailer, a discount for a line of products. The manufacturer may author a market activity for the line of products, associates the market activity with a particular campaign, and sets the status attribute to “draft.” While in draft mode, the market activity management system may be configured to only allow the author enterprise to see the market activity. The market activity may include all relevant data and information associated with the market activity for consideration by a retailer (i.e., pending recipient of the market activity). Once the author (e.g., manufacturer) is ready to send the market activity to the recipient enterprise (e.g., retailer), the status may be changed to “offer.” Setting the status to “offer” may trigger an alert via email, pager, or other electronic means. When appropriate business rules are enforced, the appropriate groups/individuals (such as those assigned to particular sales role associated with the planning items at the retailer) will receive notification that there is a new market activity for their review. Note that users 110 shown in FIG. 1 may view accessible data (based on, for example, the user's assigned role) in the system 100 either by the market activities that they are working on or by the products they are working with. Further, users 110 may sort and organize data in order to prioritize and group their work. For instance, each user may have access to multiple market activities at any given time. They may organize their data (as they relate to the market activities) based on the market activities' promotion type, campaign, authorship, and the like.

Once the draft of the market activity is completed, the market activity may be sent for approval to targeted recipient[s] as depicted in step 208 of FIG. 2A. The recipient may be an enterprise or a user of the enterprise. After the recipient[s] obtains the draft and evaluates the new market activity, the recipient[s] may agree with the terms of the offer and accept the offer. The acceptance may be indicated by a number of ways including checking a slot in the user interface, which allows the recipient[s] to either accept or deny the market activity offer. The recipient[s] may indicate their acceptance by, for example, a user interface that provides a slot for accepting the new market activity or via e-mail. The system 100 may allow the recipient to review historical performance data in order to determine whether to approve this market activity. Such data may be retrieved from logistical systems such as those described previously (e.g., collaboration application 102, monitoring application 104 and forecasting application 106). The recipient can also involve other organizations or individuals in the decision process as appropriate for their business process. In this step, the system 100 may allow for substantial interaction between the market activity author and the recipient or other parties prior to the recipient approves this market activity. The recipient may evaluate the terms of the market activity offer and indicates in the user interface that the market activity has been “approved.” The approve indication may trigger an email alert when there are business rules that forces an alert when such conditions exist. Only those individuals or groups (such as those affiliated with the market activity author or recipient) identified in the business rule will receive an alert. Further, the change of the status to approve may allow certain trading partners and their users to access (for example, view-only access) the market activity as well as other data.

Once the market activity has been approved, the market activity may be planned as depicted at step 206 as shown in FIG. 2A. In this stage, the status of the market activity may be changed to “Plan.” Planners may make a determination as to where the market activity will be run and provide a forecast for the market activity period. This may be imported from a planning system at the planning item level or at a higher level in a hierarchy. Alternatively, a total forecast number for the market activity may be entered and the forecast may be allocated across the market activity period and down a hierarchy (i.e., from product family for a region to a product at a store).

In the example above, the market activity author (e.g., manufacturer) and the recipient (e.g., retailer) may then begin collaboration on determining the sales forecast and order forecast to support the market activity. After the initial forecasts have been made, the forecasts may have to be updated as time passes. Either the author or the recipient may make these changes. Changes to these forecasts that exceed agreed upon thresholds might result in an alert being generated to the appropriate parties either based on their role or subscription. If there are changes to the data (which are time-series data) that exceeds configured thresholds, then alerts will be generated that are sent to planners and trading partners. The forecasted data together with the details of the market activity may be viewed by both the author and the recipient in a single user interface. As a result of these steps, both author and recipient are able to closely track and obtain real-time data as they relate to the progress of the market activity as it is being implemented. Further, other trading partners, such as upstream supply chain trading partners or any other interested third parties, may be allowed to keep track of the market activity.

The execution step 222 includes the movement of product[s] to distribution centers and stores as well as receiving of actual sales during the market activity. Both partners (i.e., author and recipient[s]) may monitor the execution of the market activity by analyzing the data such as actual sales data sing a collaborative information sharing system. In addition, business rules may generate alerts when execution data falls outside the realm of agreed upon thresholds. In the above example, both the retailer and manufacturer receive alerts when planned orders fall behind demand requirements or the actual sales lag or exceed forecasted demand or inventory. Users 110 shown in FIG. 1 may then receive these alerts via email, pager or other means so that a user 110 may begin analysis of the data. In analyzing the data, the user 110 may determine the root causes for the result and/or the course of action to be taken.

At any stage of the market activity or campaign, the author and the recipient[s] may want to evaluate the market activity and compare it with expected performance as well as past performance. For simple analysis of time series data, users can compare and contrast data. Business rules may be created to generate alerts for conditions during the ramp up of the market activity as well as conditions of historical data.

In order to facilitate the evaluation process, the system 100 facilitates the integration and/or viewing of various data including actual sales data, forecasting data, and the like. The market activity may be viewed individually or may be viewed together with data from other sources such as actual sales data on a single user interface thus allowing a more convenient and effective way of evaluating the market activity.

Security is applied via enterprise, roles and partnerships. In general, an enterprise may be associated with a user 110, which establishes the domain of data and system objects the user 100 has access to. Only users 110 of the author and recipient enterprise may be allowed to make changes to the market activity and market activity component data. A partnership record should already exist for these two enterprises in order for them to share market activity data.

A role defines what user defined attributes (“UDAs”) a user 110 has access to read or update (e.g., status, price, and the like). A role filter, on the other hand, specifies what data users have access to and whether they can read or update via the role filter (e.g., Product=Shampoo, Status=Plan, Update permission). Role permissions specify what actions they can perform in the system (e.g., create market activities, update components). The creation of roles is a critical piece of the overall security of the system. Therefore, permission to create and modify roles will preferably be given only to trusted users. In an exchange environment, this should probably be the host enterprise.

The system 100, according to the present invention, may include additional security features specific to market activities. When defining a role, an administrator may select a combination of read and update permissions based on the market activity status and whether the user 110 belongs to the enterprise authoring the market activity or receiving it. These permissions will work in conjunction with the UDA read/update permissions also defined in the role. Though a user may have the permission to edit data in a particular status, they can only edit attributes they have been granted editing privileges to. This is true for viewing UDAs as well.

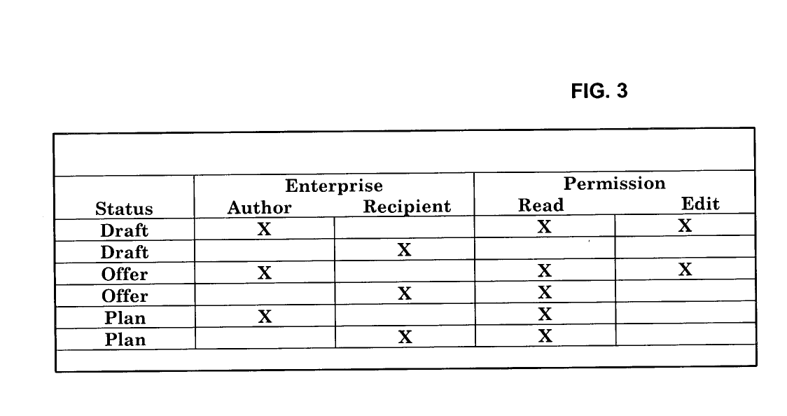

The statuses that may be displayed may be based on the statuses currently active in the system 100. In this way, a role can be defined that provides different edit and view capabilities to a user based on the status the market activity is in as well as their relationship to the market activity as author or recipient. For instance, a system user 100 may have a role that allows them to see market activities in “draft” status when their enterprise is the author, but not when they are the recipients. In addition, the role may allow them to edit data when the status is “draft” or “offer” but may allow them only to see the data with no editing authority when the status is “planning.” In all cases, however, users will only be able to see UDAs that they have been granted access to based on the role that they have been assigned to. For example, referring to FIG. 3, which is a chart that shows the types of access that may be granted to an exemplary enterprise based on the role of the enterprise (author or recipient) and the state of the status (draft, offer or plan). In this example, if the enterprise is an author then the enterprise will always have ability to “read” the market activity regardless of the state of the status. However, the author enterprise will only have editing capability when the status is at either draft or offer. If the enterprise is a recipient, then the enterprise will have read only access when status is offer or plan and no access at all when the status is at draft.

Certain actions may result in the creation of planning components (planning components are entities that can hold time series data such as forecast data). For instance, when a market activity is created, a planning component may automatically be created that is associated with the market activity to capture forecast information. Further, when a market activity is created, the authors may indicate whether they are using a shared model or secured model to exchange data with their partners. The authors may also indicate how many versions to keep for this market activity component. If they are using shared market activity, the market activity component will be editable by both the author and recipient enterprises. If they are using a secured market activity, then a market activity component will be created for both partners and they will share data by publishing to their partner. Preferably a partnership already exists between these two partners in order to create a market activity. The market activity component will automatically be added to the partnership components for these two partners.

In order to control access to specific items such as market activities, roles may be assigned to users. For example, suppose supplier A drafts a market activity for approval by retailer B. Supplier A is assigned a role that allows them to create market activities, to see all the UDAs associate with each market activities created by the supplier, and to populate all of the attributes associated with the market activity. Retailer B is assigned a role that allows them to see only market activities for Shampoo from supplier A. Retailer B can make changes to the values in the market activity, but they may not have permission to see the “Price” attribute or its value. In addition, retailer B may have several market activities that they are working with but supplier A will only see the market activities that they are working on with retailer B.

The system 100 may group market activities according to their statuses. This may be helpful to users 110 when they wish to view market activities according to their priority. For instance, among the possible status values available in the system 100 are statuses called “draft,” “offer,” “approved,” “plan,” “live,” “evaluate,” and “close.” Each of these statuses represents the state of the market activity that it is associated with. For example, the “live” status would indicate that the market activity is presently being executed. Since users 110 may be associated with several market activities at any given time, it may be preferable to be able to organize the market activities by statuses and allow the user to view market activities by groupings. Thus, those having a “live” status may require immediate attention and the user may wish to view the “live” grouping first.

System users 110 may view and edit data associated with a market activity so long as the role that have been assigned to them permits them to do so. If a user 110 does edit a market activity's data, the changes may trigger an alert and the system 100 may capture the old value, new value, the user ID and enterprise of the user making the change.

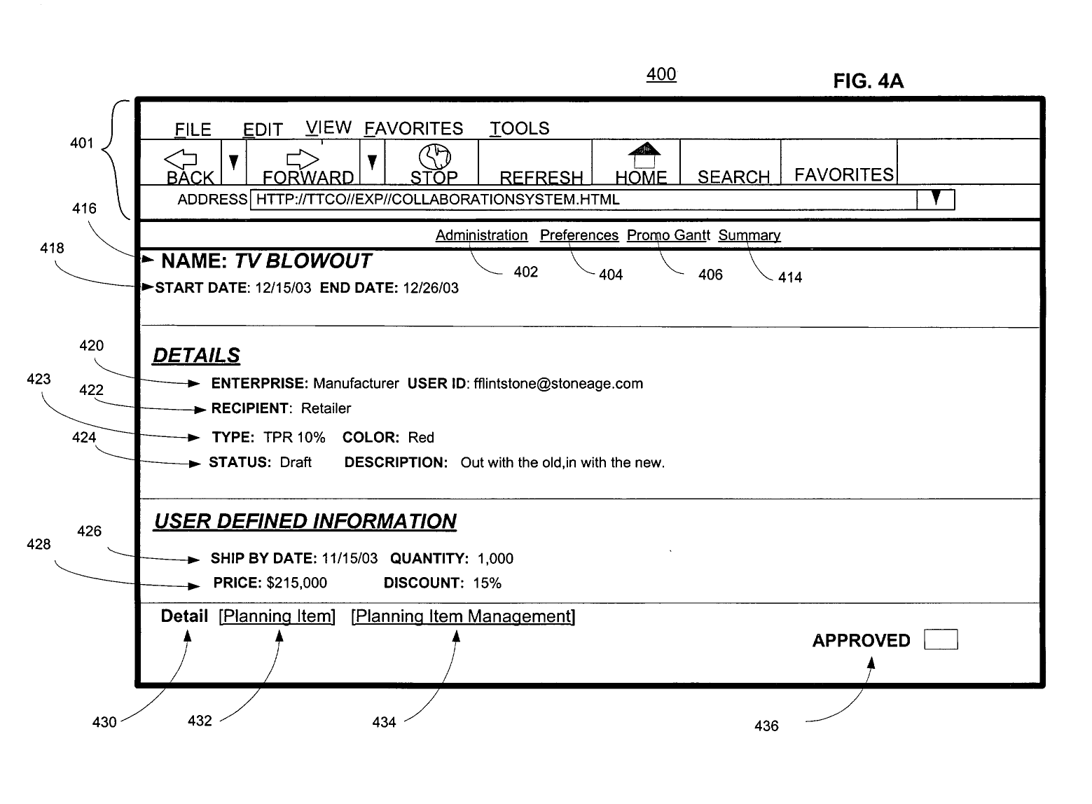

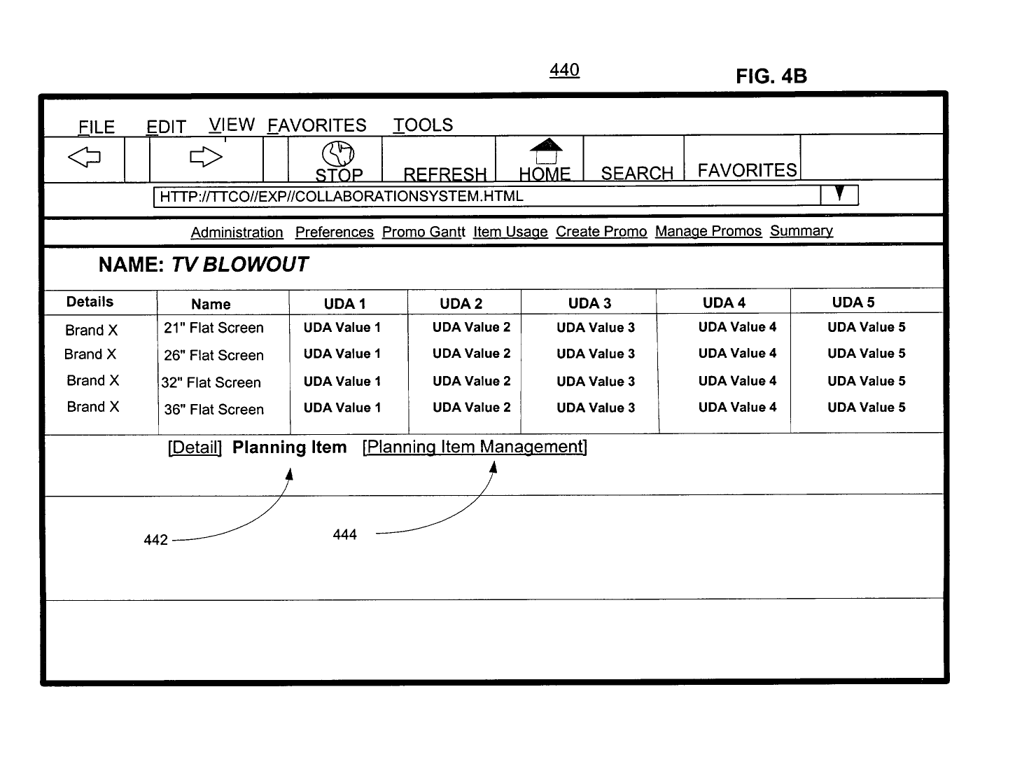

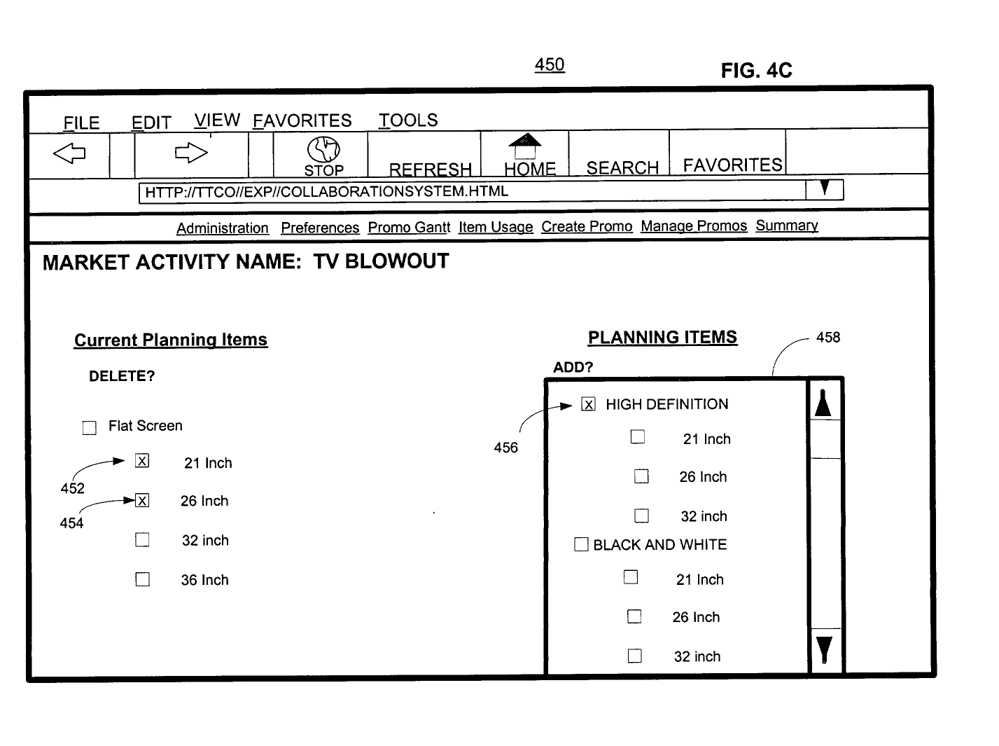

The market activity data may be viewed using commercially available browsers such as Microsoft Explorer®. FIG. 4A is a user interface for viewing an exemplary market activity. The top portion 401 of the display represents the tool bar of a browser. The interface 400 comprises of various options 402 to 414 available to system users. These options include links to an Administration Option 402, Preferences 404, Promotion Gantt 406 and Summary 414. The Administration option 402 is used to access an interface for creating, editing, deleting market activities. The Preferences option 404 is to access the interface for user preferences. The Promotion Gantt option 406 is to access a different view of the market activities organized as a calendar. Through this option, market activities for a calendar period may be viewed, what activities are running and when they are running. Further, this option allows you to view the market activities by activity types. Further, market activities details as well as forecast data may be viewed directly through the Gantt view. The Summary option 414 is used to view a list of market activities that are available to the user. Such a list may be organized by status. In this interface 400, the various attributes and attribute values associated with the market activity is shown including market activity name (i.e., “TV Blowout”) 416, start and end dates 418 (alternatively, a duration period may be used), author enterprise and user 420, recipient 422, type and color 423, status and description 424, ship by date and quantity 426 and price and discount 428. The “type” depicted at 423 may be used to define the type of market activity, for example, “2 for 1” or “10% discount.” The “color” depicted at 423 assigns a color to the “type” so that a user may color code when viewing the data in a Gantt chart. This interface 400 is a detailed view of the market activity so the detail tab 430 is highlighted. The user can select Planning items tab 432 to see all the planning items assigned to the selected market activity. Similarly, the Planning Item Management tab 434 may be clicked to view the interface for managing planning items. The detailed view 400 that is viewed by a recipient of the market activity may also include an Approval slot 436, which allows the recipient to approve the market activity.

FIG. 4B is an interface 440 showing planning items associated with the market activity “TV blowout” when the Planning Item tab 432 of FIG. 4A is “clicked.” Note that the interface is a planning item view of the market activity as indicated by 442. A user may modify or view attribute information at the planning item level for the specific market activity by selecting the planning item that he or she wishes to view or modify and view or modify accordingly.

If users 110 have the appropriate permissions, they may assign or un-assign planning items by selecting the planning item management tab 444, which will bring up a new interface 450 as shown in FIG. 4C. Users 110 may un-assign planning items from the market activity by selecting the item he or she wishes to un-assign and deleting or un-assigning the item from the market activity. In this case, the user has elected to un-assign the 21- and 26-inch flat screens as indicated by 452 and 454. Similarly, the user 110 may assign planning items to the market activity. The user 110 may “click” the appropriate planning item[s] to add to the market activity as indicated in this example by 456 from a list of unassigned planning items 458.

If the market activity component is a shared component, the author's partner planning items are used to physically store the component data. For example, it may be necessary to add a group of planning items if all flavors of one product are all on scale (i.e., different color items or different size items). For instance, batteries on sale, including size D, C, A, AA and AAA. If a planning item is added to a market activity where the forecast has already been allocated, the user must either manually enter the forecast for the planning item or re-allocate the forecast to the market activity. That is, when a planning item is added to the market activity, the forecast data is not automatically redistributed to that item since that would not make business sense. Rather, when a planning item is added, forecast data for the item must be manually added or enter a new number at an aggregate level and allocate the data that way.

Market activities may also be classified into types. Thus, particular market activities may be selectively viewed based on their “type.” That is, a user may view only certain types of market activities.

The system 100 allows users 110 to select which market activities to view. Market activities may be queried according to: group of planning items (controlled by filter and/or hierarchy structure); market activities by market activity type; specific market activity; and market activities for a specific time range (controlled by a calendar). The data may be displayed as a Gantt chart, which can provide summarized versions of all desired market activities listed in a single Gantt chart.

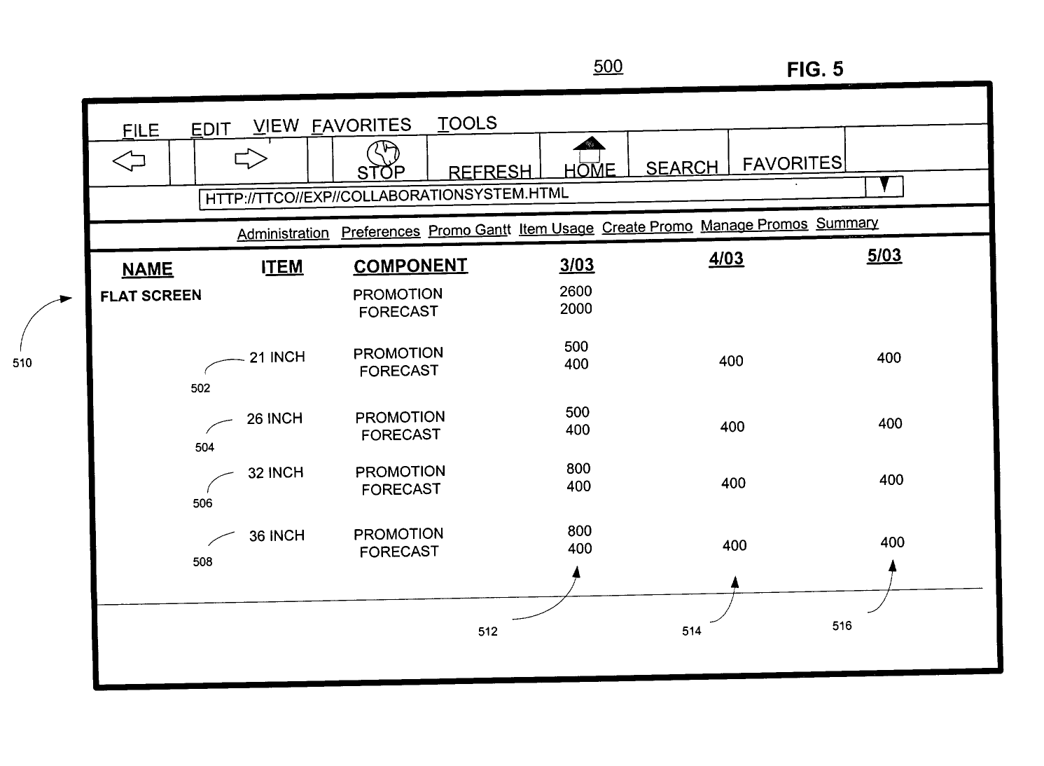

The system 100 may allow users 110 to view forecasted data (along with the market activity data), which may be further processed to provide a more user-friendly view of relevant data. The forecast data may be merged with market activity data to provide a very useful view of the relevant data. For instance, the forecasted data may be allocated based on time and planning items. That is, a user may input a forecasted quantity and the system is able to spread the quantity across time and selected planning items. The forecast value will preferably first be allocated across the market activity time period and then across the planning items assigned to the market activity for the specified filter or hierarchy branch. Before performing this operation, planning items will have preferably been assigned to the market activity. In order to allocate the forecasted values, the user selects the appropriate hierarchy and filters, then selects the appropriate branch in the hierarchy that they wish to allocate a forecast to. The following three items will preferably be defined, value, time allocation method and planning item allocation method. Once the forecast data is allocated according to the parameters of the planning items, the forecast data may then be displayed alongside corresponding market activity. Referring to FIG. 5, which is a user interface that shows how data for an exemplary market activity may be displayed alongside forecast data. This shows both promotional and market activity figures for each item 502 to 508 as well as the aggregate values for all flat screens 510. The data is spread over monthly time increments or time buckets 512 to 516. Note that there are no market activity (i.e., promotion) values after March of 2003. This is because the market activity lasts only during the month of March in this example. A user may edit the component data if they have appropriate role permissions to do so. Changes to the market activity component data may result in triggering an alert, which will be sent to appropriate parties and which may result in the capture of old value, new value, the user's ID and enterprise of the user making the change.

Time allocation may be performed by selecting a profile, which may be either “evenly” or “proportionally.” A profile is a pre-defined set of time intervals and weighted factors that indicates the spread of the forecast across the time periods in the market activity. Profiles are managed and used by the enterprise of the user that created them. Profiles are normally set up when there is a pre-determined pattern of how a market activity quantity should be spread across the period. For example, if a three week market activity typically sells 50 percent of total sales in the first week, 25 percent the second week and 25 percent the third week, then the user 110 might use a profile that had weighted factors of 50, 25 and 25. The profile periods are just buckets of time and are applied to the data based on the selected calendar. Therefore, in the above example, this profile could be used for weeks, months or quarters. In addition, negative factors can be applied to represent cannibalization of a product due to a market activity. The database may have a collection of profiles. Profiles may be used across multiple market activities to spread market activity quantity for a group of planning items over time.

If the number of periods in a profile do not equal the number of time periods for a market activity, the system 100 can still use the profile for the periods that do match. For instance, if the profile is shorter than the market activity duration, then the allocation will be based on the periods indicated in the profile and the remaining periods will be zero. If the profile is longer than the market activity, only the periods and allocation that match will be used and it may not add up to 100 percent.

Typically a planning item allocation is performed after time allocation has been completed. A planning item allocation spreads the allocated forecast value for each period of the market activity to the planning items assigned to the market activity. For planning item allocation, the user 110 specifies evenly, proportionally, or weighted by selected attribute. Once data is saved at the planning item level, the user can modify quantities at the individual or aggregate planning item or by re-allocating the forecast for the whole market activity.

The following example shows how these profiles may be used. The example shows how market activity quantity may be entered using a profile. Suppose allocation methods are defined as follows:

Allocation across time=Profile

Allocation across Planning Items=even

And the Profile is defined as follows:

Profile=‘3-week Market Activity’ (1^{st} week=50%, 2^{nd} week=25% and 3^{rd} week=25%)

Suppose further that prior to the forecasted values being added, the base forecasts for two planning items is as follows:

| Item/Date | 01/07/03 | 01/14/03 | 01/21/03 |
|---|---|---|---|
| Planning Item 1 | | | |
| Base Forecast | 200 | 300 | 400 |
| Planning Item 2 | | | |
| Base Forecast | 150 | 100 | 50 |

In order to add a market activity (in this case, “Market Activity 1”) to the forecast, a market activity for a 3-week period at the aggregate level (sum of 2 planning items) may be created as follows:

| | | | |
|---|---|---|---|
| Aggregate Planning Item | 01/07/03 | 01/14/03 | 01/21/03 |

Market Activity 1

In order to fill the data fields above, a start and end dates of the market activity and the net quantity is selected (=2000 in this case). Based on these inputs, as well as the profile, the system determines the values to use as follows:

01/07/03=2000*0.50=1000

01/14/03=2000*0.25=500

01/21/03=2000*0.25=500

The data fields now look like this:

| Aggregate Planning Item | 01/07/03 | 01/14/03 | 01/21/03 |
|---|---|---|---|
| Market Activity 1 | 1000 | 500 | 500 |

After the aggregated value (i.e., 2000) is spread across time at the aggregate level, the values are then allocated for each planning item evenly:

01/07/03

Planning Item 1=1000/2=500

Planning Item 2=1000/2=500

01/14/03

Planning Item 1=500/2=250

Planning Item 2=500/2=250

01/21/03

Planning Item 1=500/2=250

Planning Item 2=500/2=250

Based on the market activity values derived above, the new forecast looks as follows:

| Item/Date | 01/07/03 | 01/14/03 | 01/21/03 |
|---|---|---|---|
| Planning Item 1 | | | |
| Base Forecast | 200 | 300 | 400 |
| Market Activity 1 | 500 | 250 | 250 |
| Planning Item 2 | | | |
| Base Forecast | 150 | 100 | 50 |
| Market Activity 1 | 500 | 250 | 250 |

After a market activity is complete, the performance of the planned market activity can be reviewed by comparing planned market activity quantities to actual demand. The delta between these two data streams may be measured using commercially available logistical applications such as the supply chain information sharing application described previously. Further analysis of the results may be obtained using a more robust reporting and analysis application such as described in U.S. patent application Ser. No. 10/059,055 referenced above.

The market management system 100 as shown in FIG. 1 and according to an embodiment of the present invention, brings together several subsystems that allow it to provide a full range of robust information gathering and analysis capabilities. For instance, for customers with multiple levels in their hierarchy, component and market activity data may be viewed at any level. Planning items can be grouped for viewing at either an aggregated level or viewed at the individual planning item. The market activity component, which may be aggregated data, can be referenced in a derived component. A derived component is a planning component that is derived from other planning component[s]. For example, a derived component may be created with the following formula: Base Forecast+Market Activity=Net Forecast. This would provide, for example, the total expected sales based on the normal forecasted sales without any market activity plus the expected forecasted sales as a result of the market activity.

By integrating a monitoring system, such as the supply chain data monitoring application 104 depicted in FIG. 1, the market management system 100 adds, among other things, functionalities relating to monitoring of data and the generation of alerts. The alerts or notification may be based on user defined attributes. Examples of when alerts may be generated includes: when a market activity is created; when a market activity is modified or planning items assigned/un-assigned (old value, new value, user ID of person who modified); when a market activity is approved or un-approved (old value, new value, user ID of person who modified); when the status of a market activity has been changed (old value, new value, user ID of person who modified); when the performance of a past market activity exceeds a pre-defined tolerance range; and when a market activity is still in a particular state a configurable amount of time from the market activity start date (e.g., offer needs to be ready 12 weeks before in-store date, planning needs to be ready 4 weeks before in-store date).

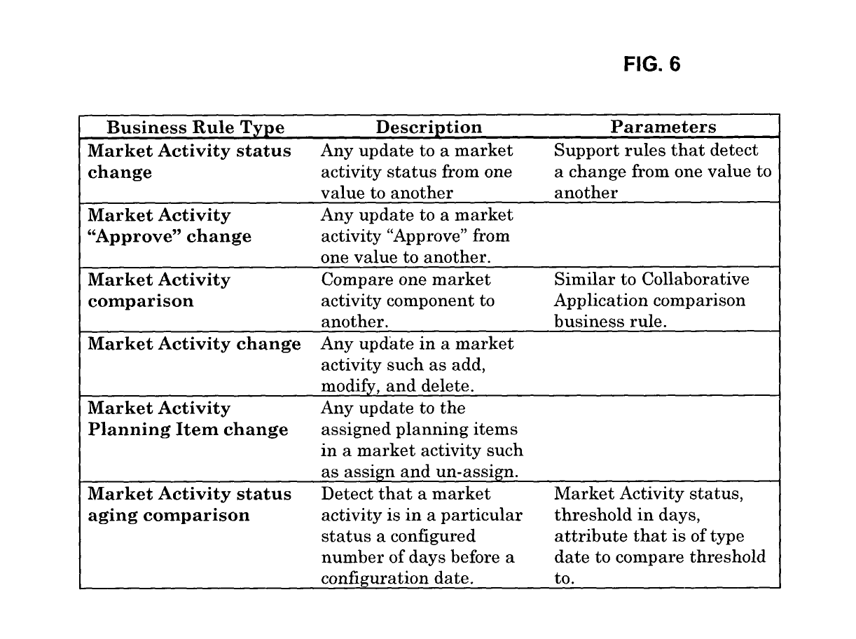

Through the monitoring application 104, business rules may be created and stored. When creating business rules, users should provide certain parameters such as business process, business rule type, business rule name, description, enterprise, priority, filter and user access. According to one embodiment of the invention, users 110 may select a business rule for application from a list of valid business rule types. Referring to FIG. 6, which is a chart that shows business rule types and required parameters that support the market management process 200. The list represents the order of priority of implementation of the business rule types.

It will be apparent to those skilled in the art that various modifications and variations can be made in the wheel assembly of the present invention without departing from the spirit or scope of the invention. Thus, it is intended that the present invention covers the modifications and variations of this invention provided that they come within the scope of any claims and their equivalents.

What is claimed:

1. A method for communicating supply chain data between a plurality of supply chain trading partners, said method comprising the steps:
creating a market activity, said market activity created by a first trading partner, said market activity having at least one attribute;
determining a status of market activity; and
allowing a second trading partner access to said market activity based upon said determined status.

2. The method of claim 1, wherein said at least one attributes is at least one of said status, an author, a recipient, an approval, a type, a market activity name, market activity description and a duration.

3. The method of claim 1, wherein said status is one of a draft status, an offer status, a planning status, an execution status and an evaluation status.

4. The method of claim 1, wherein said second trading partner has no access to said market activity when said status is a draft status.

5. The method of claim 1, wherein said second trading partner has access to said market activity when said status is at least one of an offer status, a planning status, an execution status and an evaluation status.

6. The method of claim 1, wherein at least one of said trading partners may view at least one of sales and forecasting data.

7. The method of claim 1, wherein said access is at least one of read-only and edit access.

8. The method of claim 1, wherein said allowing step is further based on roles and filters assigned to each of said plurality of trading partners.

9. The method of claim 1, further comprising the step of displaying said market activity data in a hierarchical format on a single user interface.

10. A program storage device readable by a machine, tangibly embodying a program of instructions executable by a machine, said instructions for communicating supply chain data between a plurality of supply chain trading partners, executing the steps of:
creating a market activity, said market activity created by a first trading partner, said market activity having at least one attribute;
determining a status of market activity, wherein said status is one of a draft status, an offer status, a planning status, an execution status and an evaluation status; and
allowing a second trading partner access to said market activity based upon said determined status.

11. The program storage device of claim 10, wherein said at least one attribute is one of said status, a author, a recipient, an approval, a type, a market activity name, a market activity description and a duration.

12. The program storage device of claim 10, wherein said second trading partner has no access to said market activity when said status is a draft status, and wherein said second trading partner has access to said market activity when said status is at least one of an offer status, a planning status, an execution status and an evaluation status.

13. The program storage device of claim 10, wherein at least one of said trading partners may view at least one of sales and forecasting data.

14. The program storage device of claim 10, wherein said access is at least one of read-only and edit access.

15. The program storage device of claim 10, wherein said step for determining each said trading partner's access to said market activity is based on roles and filters assigned to each said trading partner.

16. A system for communicating supply chain data between a plurality of supply chain trading partners, comprising:
a market activity manager module for creating a market activity having at least one attribute, wherein said market activity generator module receives status information of the market activity and receives a notification granting access to a trading partner based upon said status.

17. The system of claim 16, further comprising a monitoring application for supplying said status information and a security module for granting access to said trading partner based upon said status.

18. The system of claim 16, wherein said market activity manager module further comprises:
a market activity generator module for creating said market activity;
a market activity maintenance module for facilitating editing and maintenance of said market activity;
a data integrator for integrating data from logistical sources; and
a security module for granting access to said trading partner upon said status.

19. The system of claim 16, wherein said system is interfaced with a forecasting application, said forecasting application providing forecast information.

20. The system of claim 16, wherein said market activity having at least an attribute for status.

21. The system of claim 16, wherein one of said market activity attributes is at least an attribute for an author, a recipient, an approval and a type.

22. The system of claim 16, wherein said status is one of a draft status, an offer status, a planning status, an execution status and an evaluation status.
